(19) United States
(12) Patent Application Publication
(10) Pub. No.: US 2021/0246259 A1
(43) Pub. Date: Aug. 12, 2021

(54) LAYER COMPRISING CHAINS OF STABLE CARBYNE AND A METHOD FOR PREPARING THE SAME

(71) Applicant: B.G. NEGEV TECHNOLOGIES & APPLICATIONS LTD., AT BEN-GURION UNIVERSITY, Beer Sheva (IL)

(72) Inventor: Alina KARABCHEVSKY, Lehavim (IL)

(73) Assignee: B.G. NEGEV TECHNOLOGIES & APPLICATIONS LTD., AT BEN-GURION UNIVERSITY, Beer-Sheva (IL)

(21) Appl. No.: 17/273,449

(22) PCT Filed: Sep. 5, 2019
(86) PCT No.: PCT/IL2019/050990

§ 371 Date: Mar. 4, 2021

Related U.S. Application Data
(60) Provisional application No. 62/727,010, filed on Sep. 5, 2018.

(51) Int. Cl. C08G 61/04; C08K 3/08

(52) U.S. Cl. CPC C08G 61/04; C08K 3/08; C08K 2003/0831; C08G 2261/3328; C08G 2261/3422; C08G 2261/964; C08G 2261/18; C08K 2201/011

(57) ABSTRACT

The invention relates to a method for the preparation of a layer containing a plurality of linear carbyne chains, the method comprising (a) applying laser ablation on a piece of shungite in a liquid, followed by laser irradiation of the resultant carbon structures within the liquid in the presence of stabilizing metal nanoparticles, thereby to form a colloidal solution; and (b) subjecting at least a portion of said colloidal solution to AC voltage while the solution is allowed to dry, thereby to create a two-dimensional layer containing a plurality of carbyne chains.

### FIELD OF THE INVENTION

The invention relates in general to the field of material formation. More specifically, the invention relates to a method for preparing a stable carbyne from shungite.

### BACKGROUND OF THE INVENTION

Different forms of carbon have long been a subject for substantial research by chemists, physicists and engineers. Diamond, graphene, carbon nanotubes, and fullerenes, just to mention some, have a broad range of different properties. Graphene and nanotubes, for example, have recently brought significant breakthroughs in advanced science and technology. The researchers who discovered the fullerenes in the 1980's won a Nobel Prize in chemistry in 1996. Other researchers who discovered a relatively simple way to produce graphene from graphite, Andrew Geim and Konstantin Novoselov, have won a Nobel Prize in Physics in 2010 “for groundbreaking experiments regarding the two-dimensional material graphene”. Recently a new carbon-based, Q-carbon material was fabricated. And still, there is plenty of intriguing room for research and discoveries of new carbon-based materials.

Carbon is capable of forming many allotropes (structurally different forms of the same element) due to its valency. The most basic of these allotropes include diamond, graphite, graphene, and carbyne. The diamond is a three-dimensional network of tetrahedral sp³ carbon atoms that are single-bonded. Graphene has a sp² structure, formed as a two-dimensional layer, and consists of both double and single-atom bonds. Graphite is a two-dimensional sp² structure which consists a plurality of graphene-like layers, packed one above the other. In graphite the orbital hybrids and the atoms are formed in planes with each atom bonded to three nearest neighbors, 120° apart. The atoms in each of the graphite planes are bonded covalently, while only three of the four potential bonding of each atom are satisfied. The fourth electron is free to migrate in the plane, making graphite to be electrically conductive. However, it does not conduct in a direction at right angles to the plane. The bonding between the graphite layers is weak, which allows the layers of the graphite to be easily separated, or to slide one with respect to the other.

Diamond has the highest hardness and thermal conductivity of any natural material, properties that are utilized in major industrial applications, such as cutting and polishing tools. Graphene, in proportion to its thickness, is about 100 times stronger than the strongest steel. It conducts heat and electricity very efficiently and is nearly transparent.

In recent decades many more allotropes, or forms of carbon, have been discovered and researched, including ball shapes such as buckminsterfullerene and sheets such as graphene. Larger scale structures of carbon include nanotubes, nanobuds and nanoribbons. Other unusual forms of carbon exist at very high temperatures or extreme pressures.

Carbyne has a form of a linear (one-dimensional) chain of carbon atoms, that are arranged in a sp structure. The atoms in the carbyne chain are bonded in either (a) alternating triple-single electron bonds; or (b) in double electron bonds. Following theoretical predictions, the carbyne has mechanical properties that are significantly superior compared to all known materials. For example, the carbyne is 40 times stiffer than diamond, twice stiffer than graphene, and has a higher tensile strength than all other carbon materials. In addition, the predicted mechanical and electronics properties of carbyne suggest plethora of new directions in designing of nano-electronics and opto-mechanical devices. However, carbyne is extremely unstable at ambient temperature, so in practice none of these properties of the carbyne can be exploited.

There have been many tries to create carbyne which is stable at ambient temperature. For example, Pan et. al., “Carbyne with Finite Length: The One-Dimensional sp Carbon”, Sci. Adv. 2015; 1:e1500857, October 2015, suggests a two-stage process for the formation of carbyne. In a first stage, a solution of substance is synthesized using a “laser ablation in liquid (LAL)” technique, and in a second stage, the solution is purified using a high-performance liquid chromatography technique, resulting in a carbyne atom-chain. Shi et. al., “Confined Linear Carbon Chains as a Route to Bulk Carbyne”, Nature Materials Vol. 15, June 2016, suggest a technique for the formation of a long carbyne chain which may consist up to 6000 atoms. The technique of Shi et. al., however, requires heating the substance to very high temperatures, in the range of between 900° C. and 1450°.

Shungite is a black, lustrous, non-crystalline mineraloid consisting of more than 97-98 weight percent of carbon. It was first described as a deposit found near Shunga village, in Karelia, Russia, from where the shungite received its name. Probably this is one of very few locations on Earth where this mineral rock can be found. Other occurrences have been reported from Austria, India, Democratic Republic of Congo and Kazakhstan. Shungite has been reported to contain trace amounts of fullerenes. The term “shungite” was originally used in 1879 to describe a mineraloid with more than 97-98 percent carbon. More recently the term has also been used to describe shungite-bearing rocks. Shungite-bearing rocks have also been classified based on the purity of their carbon content. In the context of the present invention, the term “shungite” indicates not only the >97-98% carbon-containing mineral, for example, the mineral located in Russia, but also any rock-containing shungite where the carbon content of the mineral is above 96%.

It is an object of the present invention to provide a simple technique for creating carbyne, which at the end of the process remains stable at ambient temperature.

It is still another object of the invention to provide a technique for creating a stable carbyne, a technique which can be fully performed in an ambient temperature.

Other objects and advantages of the invention will become apparent as the description proceeds.

### SUMMARY OF THE INVENTION

The invention relates to a method for the preparation of a layer containing a plurality of linear carbyne chains, the method comprising (a) applying laser ablation on a piece of shungite in a liquid, followed by laser irradiation of the resultant carbon structures within the liquid in the presence of stabilizing metal nanoparticles, thereby to form a colloidal solution; and (b) subjecting at least a portion of said colloidal solution to AC voltage while the solution is allowed to dry, thereby to create a two-dimensional layer containing a plurality of carbyne chains.

In an embodiment of the invention, the stabilizing nanoparticles are made of gold.

In an embodiment of the invention, the laser ablation step comprises (a) a first laser illumination of the shungite within the liquid, resulting in individual carbon lamellae within the liquid; and (b) the subsequent laser irradiation comprises a second laser illumination on the individual carbon lamellae within the liquid, after removal of residual shungite and addition of gold nanoparticles to the liquid, thereby to result in said colloidal solution.

In an embodiment of the invention, first laser illumination applies energy which is significantly higher compared to the energy applied by said second laser illumination.

The invention also relates to a two-dimensional layer which contains a plurality of carbyne chains.

### BRIEF DESCRIPTION OF THE DRAWINGS

In the drawings:

FIG. 1 schematically illustrates a first stage of the method of the invention;

FIGS. 2a-2c schematically illustrate a first (LAL) stage of the invention; and

FIG. 2d schematically illustrates a second stage of the method of the invention;

FIG. 2e shows an XPS spectrum of a shungite sample that served as a starting material in the process;

FIG. 3 is another illustration of the second stage of the method of the invention;

FIG. 4a is an image showing a droplet on a copper-mesh substrate during the second stage of the method of the invention, without supply of any voltage to the electrodes;

FIG. 4b is an image showing a dried sample following a previous subjection of the electrodes to a 9V AC with frequency of 1 Hz, as in the second stage of the invention;

FIG. 4c is an enlarged portion of the image of FIG. 4b; and

FIG. 4d shows comparative results as obtained for the dried sample following subjection of the electrodes to DC voltage of 9V.

### DETAILED DESCRIPTION OF PREFERRED EMBODIMENTS

As noted, the carbyne is a carbon allotrope which is 40 times stiffer than diamond, twice stiffer than graphene, and has a higher tensile strength than all other carbon materials. However, carbyne cannot be found in nature, due to its instability at ambient temperature.

The inventors have found a simple process for the creation of a two-dimensional layer that contains a plurality (in fact many) of carbyne chains. The process in its entirety can be performed at ambient temperature. The carbyne chains remain stable within the layer at ambient temperature, following the completion of the process. It has been found that two types of layers can be created by the invention: (a) a layer consisting of chains of carbon atoms of alternate triple-single bonds; and (b) a layer consisting of chains of carbon atoms linked by double bonds. According to the invention, the carbyne chains are prepared from shungite.

The process of the invention for the preparation of carbyne from shungite is substantially a two-stage process, which may be roughly described as creation, with the aid laser irradiation, of a colloidal solution that contains gold-terminated linear carbon chains obtained from the shungite starting material, and application of AC voltage to said solution, respectively.

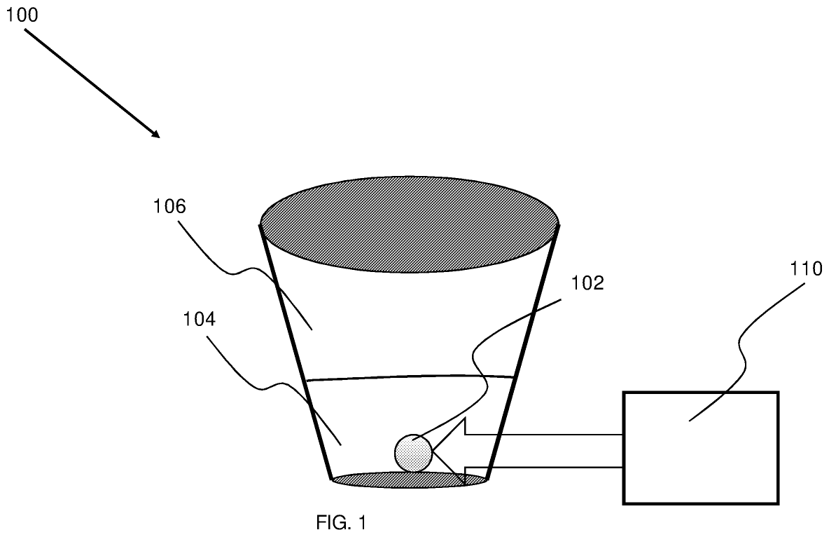

The first stage (which in fact includes two distinct irradiation steps) begins with laser ablation step 100 shown in FIG. 1. A sample (target) 102 of raw shungite is added to a certain volume of deionized water 104 within a container 106 (in one example, a 3 mm³ piece of shungite mineraloid was added to lmL of deionized water). The shungite is then illuminated by a LAL (Laser in Liquid) first-step illumination. A plurality of unstable chains of carbon atoms (not shown) are formed within the deionized water 104. The chains are unstable in the sense that, absent of two “anchor” atoms at the two ends of the chain, respectively, their atoms “try” to connect to other chains in the liquid in some irregular and uncontrolled manner. More specifically, they do not form stable carbyne chains (this is expected, as carbyne chains are known to be unstable at ambient temperature).

Then, in the second irradiation step of the first stage, the residual shungite 102 is removed from the liquid, and gold (Au) nanoparticles (in one example, of 60 nm diameter) are added to the solution (not shown). The previously formed linear chains, together with the gold nanoparticles are illuminated by laser to activate the connection of the linear carbon chains to the anchoring gold nanoparticles.

The laser irradiation stage 100 described above is substantially as described by Pan et. al.—see the Background of the Invention” section above. The laser irradiation stage is applied by a laser generator 110.

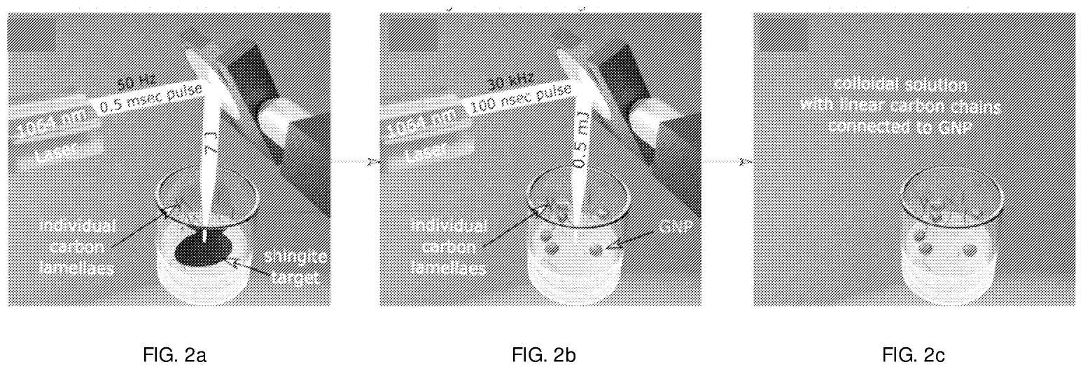

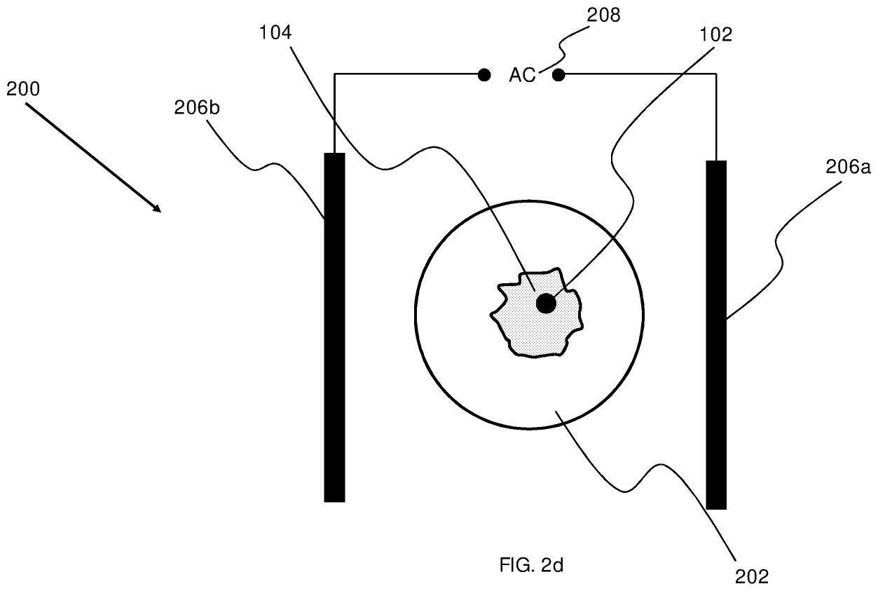

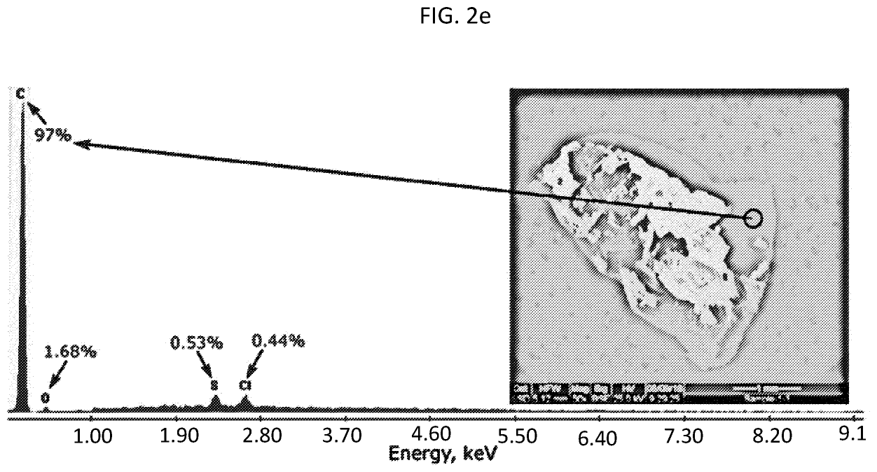

At the end of the Laser Ablation/laser irradiation in Liquid stage 100, a portion from liquid 104 with unstable carbon chains contained therein, is placed on a substrate 202, as shown in the schematic top view of FIG. 2d.

The second stage of the process for the creation of stable chains of carbyne is described by FIG. 2d. In the second stage, the substrate 202 is placed between two electrodes (for example, each having an area of 1 mm²), 206a and 206b. An AC voltage (in one example, 9V, 1 Hz) is applied to the two electrodes. It has been surprisingly found that the AC voltage causes the creation within the water of many discrete carbyne chains, each being anchored at its two ends by two gold atoms, respectively. Each of the created chains in fact contains a plurality of carbon atoms, that are anchored at their ends by two atoms of gold. Each created chain is, to some degree, parallel to the other chains. Most important, it has also been found that upon drying of the water (while the AC voltage is still applied to the electrodes 206a and 206b), the carbyne chains remain stable within a 2D layer which is formed.

Interestingly, and as shown below, the application of DC voltage in the second stage of the process, in lieu of AC voltage, does not lead to the creation of carbyne chains terminated by gold atoms, but rather to “carbon cages” in which the gold nanoparticles are encapsulated. Hence an independent aspect of the technology disclosed herein is a process for encapsulating nanoparticles, e.g., gold nanoparticles, wherein, in the second stage of the process, DC voltage is applied.

Experiment

The first stage of the process includes two laser irradiation steps. This stage as experimentally performed by the inventors, is schematically shown in FIGS. 2a-2c. Initially, and as shown in FIG. 2a, a piece (sample) of shungite mineraloid (target) having a volume of 3 mm³ was placed within a container that contained 1 mL of deionized water. Next, the shungite sample was subjected to a first step of laser irradiation, i.e., a laser ablation accomplished by an illumination of laser 1064 nm, 0.5 ms pulse, 50 Hz, 7J. The laser illumination has produced a plurality of individual carbon lamellae. In a next step shown in FIG. 2b, the residual shungite was removed from the liquid, and gold (Au) nanoparticles (GNP) (60 nm diameter each, purchased from Sigma Aldrich) were added to the liquid. The liquid, containing the carbon lamellae and GNP, was then subjected to a second step of laser irradiation—1064 nm, 100 ns pulse, 30 kHz, 0.5 mJ. The first stage of FIGS. 2a-2b, as described, resulted in a colloidal solution that included linear carbon chains, each chain having a GNP atom (FIG. 2c) at each of the two ends of the chain. FIG. 2e shows the XPS energy spectrum of the shungite mineral that was used as a starting material. The spectrum indicates carbon content >97%.

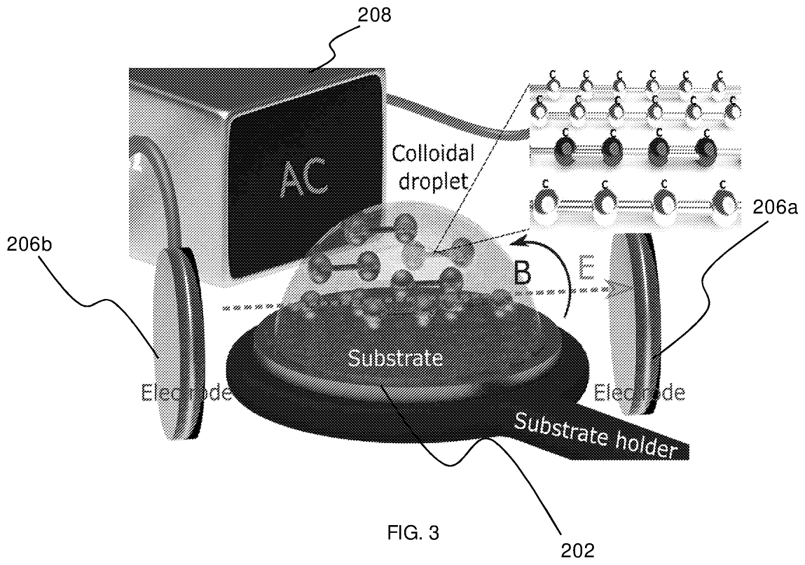

FIG. 3 and FIG. 2d illustrate the second stage of the process of the invention. In a non-binding theory, the inventor believes that the explanation to the phenomenon resides in the Lorentz Law. A sample from the resulting liquid of FIG. 2c was placed on a substrate 202 made of a copper—mesh. Two metallic electrodes 206a and 206b were placed next to the substrate 202. Each of the electrodes had a radius of 1 mm, and they were spaced 1 mm apart from one another. The electrodes were connected to an AC source operating, in this specific case, at amplitude of 9V and a frequency of 1 Hz. It should be noted that same results were obtained in the frequency range of 0.5 Hz-5 Hz (resolution steps of 0.5 Hz were tested). The AC voltage was applied in a duration of lhr.

The electrodes generated electromagnetic field that in turn caused an electric current to flow within the carbon wires. Lorentz force between the current and the field, stretched the wires (chains) in the liquid. When the liquid was naturally dried, the wires were stretched and aligned on the substrate 202. The direction of the electric field E has changed direction together with the magnetic field B which changed the rotation direction (clockwise or contraclockwise of magnetic field B). More specifically, current was induced on the carbon wire due to the varying magnetic field under the AC current. Therefore, the current-carrying carbon wires, being in a magnetic field, were subjected to a Lorentz force F in a direction given by Fleming's left-hand rule, with a magnitude of:

F=BIlsinθ

where F is the force, l is the length of the carbon wire in the magnetic field, I is the current flowing through the carbon wire and θ is the angle between the carbon wire and the magnetic field having a magnetic field strength B. It should be noted that even though the carbon wires positioned themselves with an angle θ to the magnetic field, the direction of the force F was not changed. This explains, the fact that the deposited carbon wires on a substrate has a certain angle. The stretching was realized perpendicular to the electromagnetic field direction E between two electrodes.

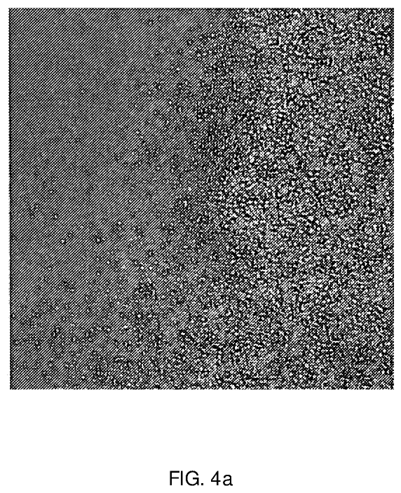

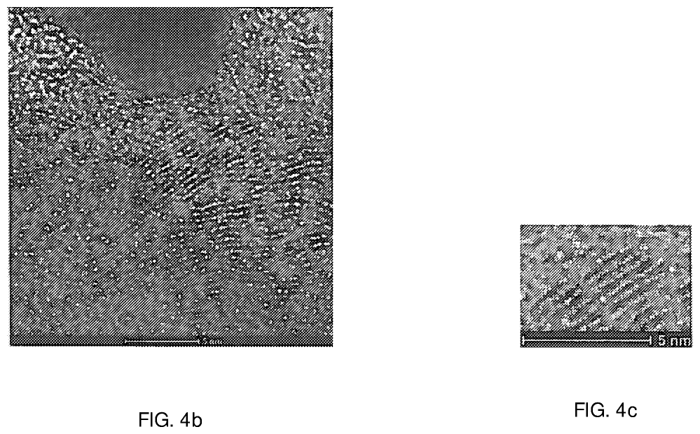

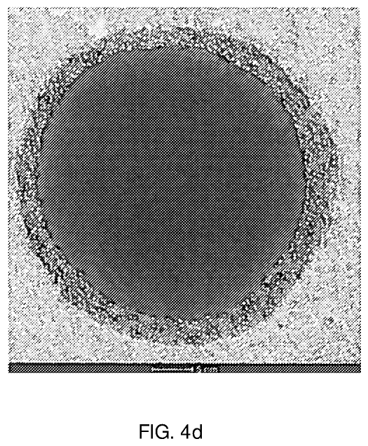

A high-resolution Transmission Electron Microscope (TEM) was used to investigate the results of the experiment. FIG. 4a shows the image of the droplet on a copper—mesh substrate without any voltage to the electrodes 202. It can be realized that the image does not show any specific order of the atoms. The darker portion represents a collection of gold nanospheres each having 60 nm diameter. FIG. 4b shows the image of the dried droplet (namely, after it was dried) following a previous subjection of the electrodes to a 9V, 1Hz AC. FIG. 4c shows an enlarged portion of the image of FIG. 4b. As can be clearly seen, many of stable carbon atom-chains are realized.

FIG. 4d shows comparative results as obtained for the dried droplet following a subjection of the electrodes to DC voltage of 9V (rather than 9V AC as performed in the previous test). It can be clearly seen that there are no chains whatsoever. Instead, it can be realized that the carbon atoms encapsulate the gold “anchor” atoms (the gold atoms are the indicated by the darker section at the center of the image).

The inventors believe that the carbyne chains that were realized in the images of FIGS. 4b and 4c in fact reflect two types of bonds: (a) alternating triple-single bonds; and/or (b) double bonds. In both cases, electrons from the gold atoms were used as anchors at the two ends of the chains. The inventor also believes that there is no limitation to the length of the carbyne chains that can be produced by the invention. The larger the shungite sample is, and the longer time is used during the first stage of the laser ablation, longer carbyne chains can be obtained.

As shown, the present invention provides a simple method for the creation of stable linear chains of carbyne in an ambient temperature. The carbyne chains, due to their unique characteristics, may have many important and valuable applications, for example, an extremely strong rope may be prepared from a plurality of such carbyne chains. Other examples are novel types of extremely stiff and durable materials and textiles.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for the preparation of a layer containing a plurality of linear carbyne chains, comprising:
a) applying laser ablation on a piece of shungite in a liquid, followed by laser irradiation of the resultant carbon structures within the liquid in the presence of stabilizing metal nanoparticles, thereby to form a colloidal solution; and
b) subjecting at least a portion of said colloidal solution to AC voltage, while the solution is allowed to dry, thereby to create a two-dimensional layer containing a plurality of carbyne chains.

2. The method of claim 1, wherein said stabilizing nanoparticles are made of gold.

3. The method of claim 1, wherein said liquid is deionized water.

4. The method of claim 1, wherein the laser ablation step comprises:
a) a first laser illumination of the shungite within the liquid, resulting in individual carbon lamellae within the liquid; and
b) the subsequent laser irradiation comprises a second laser illumination on the individual carbon lamellae within the liquid, after removal of residual shungite and addition of gold nanoparticles to the liquid, thereby to result in said colloidal solution.

5. The method of claim 1, wherein said first laser illumination applies energy which is significantly higher compared to the energy applied by said second laser illumination.

6. The method of claim 1, wherein the frequency of the AC voltage is in the range of between 0.5 Hz and 5 Hz.

7. A two-dimensional layer containing a plurality of carbyne chains.
